(19) United States
(12) Patent Application Publication
(10) Pub. No.: US 2016/0010568 A1
(43) Pub. Date: Jan. 14, 2016

(54) SELECTIVELY DEACTIVATABLE ENGINE CYLINDER

(71) Applicant: Ford Global Technologies, LLC, Dearborn, MI (US)

(72) Inventors: Phil John Whiston, Ingatestone (GB); Neil Haynes, Benfleet (GB)

(21) Appl. No.: 14/789,335

(22) Filed: Jul. 1, 2015

(30) Foreign Application Priority Data
Jul. 14, 2014 (GB) 1412482.0

(51) Int. Cl. F02D 13/06; F02F 1/18; F01L 1/18; F02D 13/02

(52) U.S. Cl. CPC F02D 13/06; F02D 13/0207; F02F 1/18; F01L 1/18

(57) ABSTRACT

An engine comprising: one or more multi-valve cylinders, each multi-valve cylinder having a plurality of intake valves and/or a plurality of exhaust valves; and one or more further cylinders, each further cylinder having fewer intake valves and/or fewer exhaust valves than each multi-valve cylinder, wherein a cylinder deactivation system of the engine is configured to selectively deactivate at least one further cylinder.

### CROSS REFERENCE TO RELATED APPLICATIONS

The present application claims priority to Great Britain Patent Application No. 1412482.0, filed Jul. 14, 2014, entitled, “Selectively Deactivatable Engine Cylinder,” the entire contents of which are hereby incorporated by reference for all purposes.

### FIELD

This disclosure relates to an engine comprising one or more multi-valve cylinders.

### BACKGROUND/SUMMARY

During normal driving conditions it is uncommon for a driver of a vehicle to request maximum engine power for a prolonged period of operation and the engine may typically operate at a low percentage of its maximum power for a proportion of its operation, for example during low-load driving conditions. At low load, the throttle of the engine is substantially closed and the pressure in the cylinders of the engine is low. As such, the engine has to work to draw air into the cylinders, which causes a pumping loss resulting in reduced engine efficiency and lower fuel economy of the vehicle.

For multi-cylinder engines, cylinder deactivation may be implemented during low-load driving conditions to reduce the number of cylinders drawing air from the intake manifold. Cylinder deactivation at lower engine output has proven benefits of increasing the fuel economy of the engine and decreasing the emission of pollutants with the exhaust gases.

However, the inventors herein have recognized an issue with the above configuration. In order to deactivate the cylinder, the cylinder must be fitted with a deactivation system, for example a switchable mechanism configured to disengage the intake valves and/or the exhaust valves of the cylinder from a camshaft of the engine. Such deactivation systems may be complex and expensive to install and may only be operable for a small proportion of the engine's operation.

According to an aspect of the present disclosure there is provided an engine, for example an engine of a motor vehicle. The engine comprises one or more multi-valve cylinders, each multi-valve cylinder having a plurality of intake valves and/or a plurality of exhaust valves. The engine comprises one or more further cylinders, each further cylinder having fewer intake valves and/or fewer exhaust valves than each multi-valve cylinder. A cylinder deactivation system of the engine is configured to selectively deactivate at least one of the one or more further cylinders.

The valve lift height of at least one intake valve and/or at least one exhaust valve of each further cylinder may be greater than that of the intake valves and/or the exhaust valves of the one or more one multi-valve cylinders.

At least one intake valve and/or at least one exhaust valve of each further cylinder may be larger, for example may be of a larger diameter and/or opening size, than the intake valves and/or the exhaust valves of the one or more one multi-valve cylinders.

The cylinder deactivation system may comprise one or more switchable mechanisms configured to selectively disengage at least one intake valve and/or at least one exhaust valve of at least one of the further cylinders from a camshaft of the engine.

The cylinder deactivation system may comprise one or more switchable roller finger followers. The switchable roller finger followers may be configured to selectively actuate at least one intake valve and/or at least one exhaust valve of at least one further cylinder, for example for the purpose of cylinder deactivation. Each switchable roller finger follower may comprise one or more hydraulic elements configured to adjust the operational configuration of the switchable roller finger follower, thereby enabling the selective actuation of at least one intake valve and/or at least one exhaust valve of at least one further cylinder.

The cylinder deactivation system may comprise one or more collapsible lash adjusters. The collapsible lash adjusters may be configured to selectively decouple at least one intake valve and/or at least one exhaust valve of at least one further cylinder from a rocker arm or cam follower, for example for the purpose of cylinder deactivation. Each collapsible lash adjuster may comprise one or more hydraulic elements configured to adjust the operational configuration of the collapsible lash adjuster, thereby enabling the selective decoupling of at least one intake valve and/or at least one exhaust valve of at least one further cylinder.

The cylinder deactivation system may comprise a hydraulic system, for example a hydraulic circuit, configured to supply hydraulic fluid to the one or more hydraulic elements of the switchable roller finger followers and/or the collapsible lash adjusters.

The cylinder deactivation system may be configured to selectively deactivate at least one multi-valve cylinder. The cylinder deactivation system may be configured to selectively deactivate a combination of at least one further cylinder and at least one multi-valve cylinder. The cylinder deactivation system may be configured to partially deactivate at least one further cylinder and/or at least one multi-valve cylinder. For example, the cylinder deactivation system may be configured to selectively deactivate one or more of a plurality of intake valves and/or one or more of a plurality of exhaust valves of at least one further cylinder. The cylinder deactivation system may be configured to selectively deactivate one of a plurality of intake valves and/or one or more of a plurality of exhaust valves of at least one multi-valve cylinder.

Each multi-valve cylinder may comprise any appropriate number of intake valves and/or exhaust valves. Each further cylinder may comprise any appropriate number of intake valves and/or exhaust valves that is fewer than the number of intake and/or exhaust valves of the multi-valve cylinders. For example, each multi-valve cylinder may comprise two intake valves. Each multi-valve cylinder may comprise two exhaust valves. Each further cylinder may comprise one intake valve. Each further cylinder may comprise one exhaust valve.

The engine may comprise a control device configured to control the cylinder deactivation system. The control device may be configured to deactivate at least one further cylinder. The control device may be configured to adjust, for example increase or decrease, the valve lift height of at least one intake valve and/or at least one exhaust valve of at least one further cylinder. The control device may be configured to deactivate at least one multi-valve cylinder. The control device may be configured to adjust, for example increase or decrease, the valve lift height of at least one intake valve and/or at least one exhaust valve of at least one multi-valve cylinder. The control device may be configured to control the engine, for example control the power output and/or emissions in the exhaust gases of the engine.

The motor vehicle may comprise one or more of the above-described engines. The motor vehicle may comprise one or more of the control devices.

According to another aspect of the present disclosure there is provided a method of controlling an engine, wherein the engine comprises: one or more multi-valve cylinders, the or each multi-valve cylinder having a plurality of intake valves and/or a plurality of exhaust valves; and one or more further cylinders, the or each further cylinder having fewer intake valves and/or fewer exhaust valves than the or each multi-valve cylinder. The method comprises deactivating the or at least one of each further cylinder of the engine by way of a cylinder deactivation system.

The method may comprise adjusting, for example increasing or decreasing, the valve lift height of at least one intake valve and/or at least one exhaust valve of the or at least one of each further cylinder. The method may comprise deactivating the or at least one of each multi-valve cylinder.

The method may comprise adjusting, for example increasing or decreasing, the valve lift height of at least one intake valve and/or at least one exhaust valve of the or at least one of each multi-valve cylinder. The method may comprise adjusting, for example speeding up or slowing down, the timing of at least one intake valve and/or at least one exhaust valve of the or at least one of each further cylinder.

The method may comprise adjusting, for example speeding up or slowing down, the timing of at least one intake valve and/or at least one exhaust valve of the or at least one of each multi-valve cylinder.

The present disclosure also provides software, such as a computer program or a computer program product for carrying out any of the methods described herein, and a computer readable medium having stored thereon a program for carrying out any of the methods described herein. A computer program embodying the present disclosure may be stored on a computer-readable medium, or it could, for example, be in the form of a signal such as a downloadable data signal provided from an Internet website, or it could be in any other form.

### BRIEF DESCRIPTION OF THE DRAWINGS

FIG. 1A illustrates an example cylinder of a multi-cylinder engine.

FIG. 1B illustrates an example multi-cylinder engine.

FIG. 2 is a flow chart illustrating a method for operating an engine.

### DETAILED DESCRIPTION

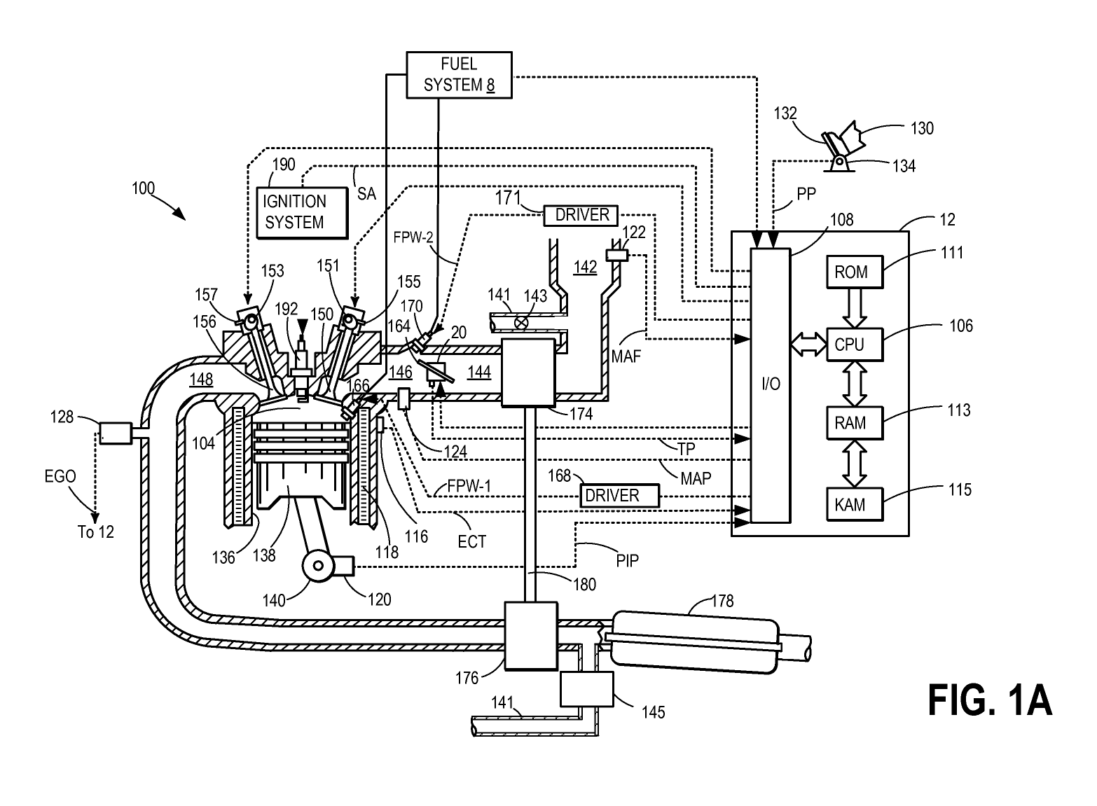

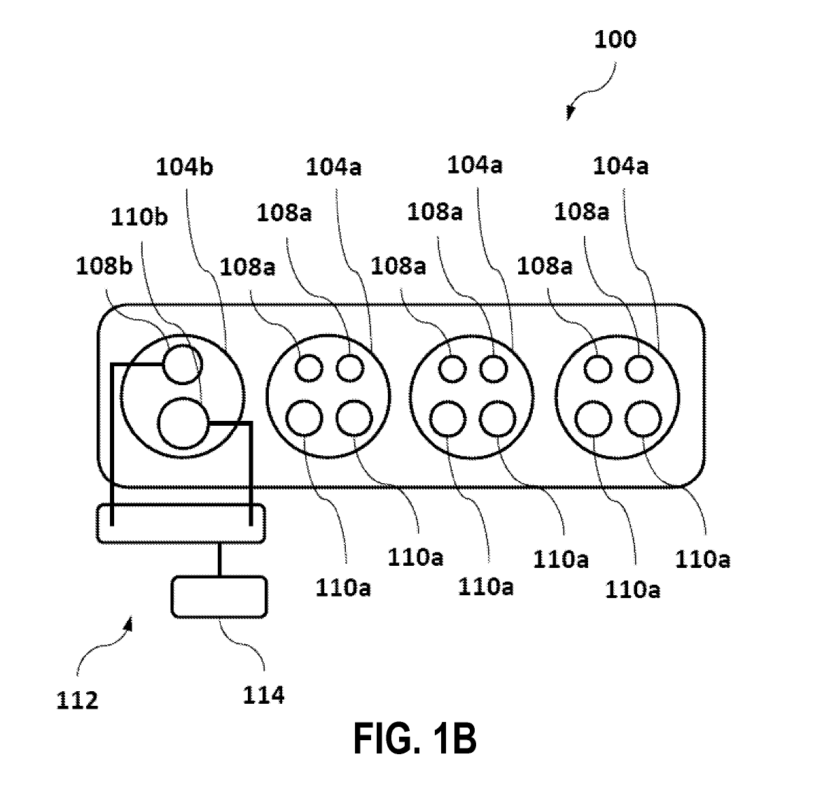

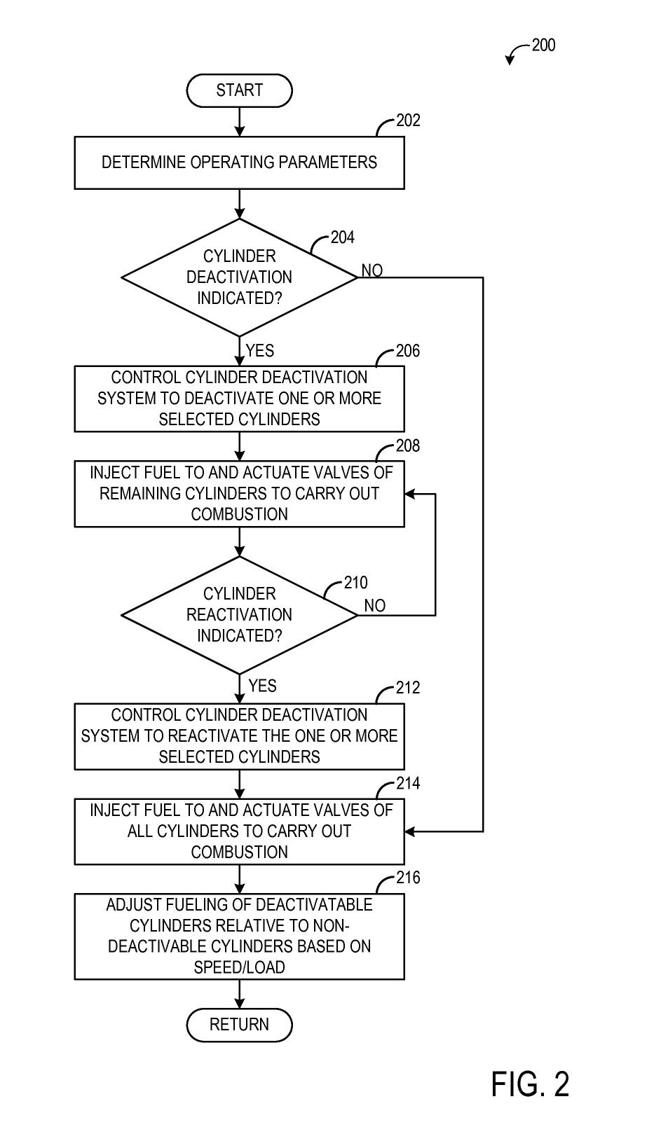

It is generally known that deactivating one or more cylinders of an engine can increase the fuel economy of the engine during low-load operation. Cylinder deactivation may be achieved by preventing the valves of the cylinder from opening during engine operation, for example by shutting off the air supply to and/or from the cylinder. This reduces the number of cylinders in operation at any given time. The present disclosure provides one or more cylinders of an engine with a valve configuration, and a methodology for deactivating one or more cylinders of the engine. FIG. 1A illustrates an example cylinder that may be included as part of a multi-cylinder engine. FIG. 1B illustrates an example multi-cylinder engine including a deactivatable cylinder and a plurality of non-deactivatable cylinders, where the deactivatable cylinder has fewer intake and/or exhaust valves than the non-deactivatable cylinders. FIG. 2 is a method for operating the engine of FIG. 1B.

FIG. 1A depicts an example embodiment of a combustion chamber or cylinder of internal combustion engine 100. Engine 100 may receive control parameters from a control system including controller 12 and input from a vehicle operator 130 via an input device 132. In this example, input device 132 includes an accelerator pedal and a pedal position sensor 134 for generating a proportional pedal position signal PP. Cylinder (herein also “combustion chamber”) 104 of engine 10 may include combustion chamber walls 136 with piston 138 positioned therein. Piston 138 may be coupled to crankshaft 140 so that reciprocating motion of the piston is translated into rotational motion of the crankshaft. Crankshaft 140 may be coupled to at least one drive wheel of the passenger vehicle via a transmission system. Further, a starter motor may be coupled to crankshaft 140 via a flywheel to enable a starting operation of engine 100.

Cylinder 104 can receive intake air via a series of intake air passages 142, 144, and 146. Intake air passage 146 may communicate with other cylinders of engine 100 in addition to cylinder 104. In some embodiments, one or more of the intake passages may include a boosting device such as a turbocharger or a supercharger. For example, FIG. 1A shows engine 100 configured with a turbocharger including a compressor 174 arranged between intake passages 142 and 144, and an exhaust turbine 176 arranged along exhaust passage 148. Compressor 174 may be at least partially powered by exhaust turbine 176 via a shaft 180 where the boosting device is configured as a turbocharger. However, in other examples, such as where engine 100 is provided with a supercharger, exhaust turbine 176 may be optionally omitted, where compressor 174 may be powered by mechanical input from a motor or the engine. A throttle 20 including a throttle plate 164 may be provided along an intake passage of the engine for varying the flow rate and/or pressure of intake air provided to the engine cylinders. For example, throttle 20 may be disposed downstream of compressor 174, or alternatively may be provided upstream of compressor 174.

Exhaust passage 148 may receive exhaust gases from other cylinders of engine 100 in addition to cylinder 104. Exhaust gas sensor 128 is shown coupled to exhaust passage 148 upstream of emission control device 178. Sensor 128 may be selected from among various suitable sensors for providing an indication of exhaust gas air/fuel ratio such as a linear oxygen sensor or UEGO (universal or wide-range exhaust gas oxygen), a two-state oxygen sensor or EGO (as depicted), a HEGO (heated EGO), a NOx, HC, or CO sensor, for example. Emission control device 178 may be a three way catalyst (TWC), NOx trap, various other emission control devices, or combinations thereof.

Exhaust temperature may be measured by one or more temperature sensors (not shown) located in exhaust passage 148. Alternatively, exhaust temperature may be inferred based on engine operating conditions such as speed, load, air-fuel ratio (AFR), spark retard, etc. Further, exhaust temperature may be computed by one or more exhaust gas sensors 128. It may be appreciated that the exhaust gas temperature may alternatively be estimated by any combination of temperature estimation methods listed herein.

Each cylinder of engine 100 may include one or more intake valves and one or more exhaust valves. For example, cylinder 104 is shown including at least one intake poppet valve 150 and at least one exhaust poppet valve 156 located at an upper region of cylinder 104. In some embodiments, each cylinder of engine 100, including cylinder 104, may include at least two intake poppet valves and at least two exhaust poppet valves located at an upper region of the cylinder.

Intake valve 150 may be controlled by controller 12 by cam actuation via cam actuation system 151. Similarly, exhaust valve 156 may be controlled by controller 12 via cam actuation system 153. Cam actuation systems 151 and 153 may each include one or more cams and may utilize one or more of cam profile switching (CPS), variable cam timing (VCT), variable valve timing (VVT) and/or variable valve lift (VVL) systems that may be operated by controller 12 to vary valve operation. The operation of intake valve 150 and exhaust valve 156 may be determined by valve position sensors (not shown) and/or camshaft position sensors 155 and 157, respectively. In alternative embodiments, the intake and/or exhaust valve may be controlled by electric valve actuation. For example, cylinder 104 may alternatively include an intake valve controlled via electric valve actuation and an exhaust valve controlled via cam actuation including CPS and/or VCT systems. In still other embodiments, the intake and exhaust valves may be controlled by a common valve actuator or actuation system, or a variable valve timing actuator or actuation system.

In some embodiments, each cylinder of engine 100 may include a spark plug 192 for initiating combustion. Ignition system 190 can provide an ignition spark to combustion chamber 104 via spark plug 192 in response to spark advance signal SA from controller 12, under select operating modes.

In some embodiments, each cylinder of engine 10 may be configured with one or more injectors for delivering fuel to the cylinder. As a non-limiting example, cylinder 104 is shown including two fuel injectors 166 and 170. Fuel injectors 166 and 170 may be configured to deliver fuel received from fuel system 8 via a high pressure fuel pump, and a fuel rail. Alternatively, fuel may be delivered by a single stage fuel pump at lower pressure, in which case the timing of the direct fuel injection may be more limited during the compression stroke than if a high pressure fuel system is used. Further, the fuel tank may have a pressure transducer providing a signal to controller 12.

Fuel injector 166 is shown coupled directly to cylinder 104 for injecting fuel directly therein in proportion to the pulse width of signal FPW-1 received from controller 12 via electronic driver 168. In this manner, fuel injector 166 provides what is known as direct injection (hereafter referred to as “DI”) of fuel into combustion cylinder 104. While FIG. 1A shows injector 166 positioned to one side of cylinder 104, it may alternatively be located overhead of the piston, such as near the position of spark plug 192. Such a position may improve mixing and combustion when operating the engine with an alcohol-based fuel due to the lower volatility of some alcohol-based fuels. Alternatively, the injector may be located overhead and near the intake valve to improve mixing. Fuel injector 170 is shown arranged in intake passage 146, rather than in cylinder 104, in a configuration that provides what is known as port injection of fuel (hereafter referred to as “PFI”) into the intake port upstream of cylinder 104. Fuel injector 170 may inject fuel, received from fuel system 8, in proportion to the pulse width of signal FPW-2 received from controller 12 via electronic driver 171. Note that a single driver 168 or 171 may be used for both fuel injection systems, or multiple drivers, for example driver 168 for fuel injector 166 and driver 171 for fuel injector 170, may be used, as depicted.

Fuel injectors 166 and 170 may have different characteristics. These include differences in size, for example, one injector may have a larger injection hole than the other. Other differences include, but are not limited to, different spray angles, different operating temperatures, different targeting, different injection timing, different spray characteristics, different locations etc. Moreover, depending on the distribution ratio of injected fuel among injectors 166 and 170, different effects may be achieved.

Fuel may be delivered by both injectors to the cylinder during a single cycle of the cylinder. For example, each injector may deliver a portion of a total fuel injection that is combusted in cylinder 104. As such, even for a single combustion event, injected fuel may be injected at different timings from the port and direct injector. Furthermore, for a single combustion event, multiple injections of the delivered fuel may be performed per cycle. The multiple injections may be performed during the compression stroke, intake stroke, or any appropriate combination thereof.

As described above, FIG. 1A shows only one cylinder of a multi-cylinder engine. As such each cylinder may similarly include its own set of intake/exhaust valves, fuel injector(s), spark plug, etc. It will be appreciated that engine 100 may include any suitable number of cylinders, including 2, 3, 4, 5, 6, 8, 10, 12, or more cylinders. Further, each of these cylinders can include some or all of the various components described and depicted by FIG. 1A with reference to cylinder 104.

The engine may further include one or more exhaust gas recirculation passages for recirculating a portion of exhaust gas from the engine exhaust to the engine intake. As such, by recirculating some exhaust gas, an engine dilution may be affected which may improve engine performance by reducing engine knock, peak cylinder combustion temperatures and pressures, throttling losses, and NOx emissions. In the depicted embodiment, exhaust gas may be recirculated from exhaust passage 148 to intake passage 144 via EGR passage 141. The amount of EGR provided to intake passage 144 may be varied by controller 12 via EGR valve 143. Further, an EGR sensor 145 may be arranged within the EGR passage and may provide an indication of one or more pressure, temperature, and concentration of the exhaust gas.

Controller 12 is shown in FIG. 1 as a microcomputer, including microprocessor unit 106, input/output ports 108, an electronic storage medium for executable programs and calibration values shown as read only memory chip 111 in this particular example, random access memory 113, keep alive memory 115, and a data bus. Controller 12 may receive various signals from sensors coupled to engine 10, in addition to those signals previously discussed, including measurement of inducted mass air flow (MAF) from mass air flow sensor 122; engine coolant temperature (ECT) from temperature sensor 116 coupled to cooling sleeve 118; a profile ignition pickup signal (PIP) from Hall effect sensor 120 (or other type) coupled to crankshaft 140; throttle position (TP) from a throttle position sensor; and manifold absolute pressure signal

(MAP) from sensor 124. Engine speed signal, RPM, may be generated by controller 12 from signal PIP. Manifold pressure signal MAP from a manifold pressure sensor may be used to provide an indication of vacuum, or pressure, in the intake manifold. Still other sensors may include fuel level sensors and fuel composition sensors coupled to the fuel tank(s) of the fuel system.

Storage medium read-only memory 111 can be programmed with computer readable data representing instructions executable by processor 106 for performing the methods described below as well as other variants that are anticipated but not specifically listed.

As explained above, engine 100 may include multiple cylinders. FIG. 1B schematically illustrates engine 100 including multiple cylinders 104a-104b. Cylinder 104 described above with respect to FIG. 1A is one non-limiting example of each or any of cylinders 104a-b. Engine 100, for example an engine of a motor vehicle, comprises one or more multi-valve cylinders 104a and one or more further cylinders 104b. Each multi-valve cylinder 104a comprises a plurality of intake valves 108a and/or a plurality of exhaust valves 110a. Each further cylinder 104b comprises one or more intake valves 108b and/or one or more exhaust valves 110b. In particular, each further cylinder 104b comprises fewer intake valves 108b and/or fewer exhaust valves 110b than each multi-valve cylinder 104a.

In the example shown in FIG. 1B, the engine is a four-cylinder engine 100 comprising three multi-valve cylinders 104a and one further cylinder 104b. Each of the multi-valve cylinders 104a comprises a pair of intake valves 108a and a pair of exhaust valves 110a. The further cylinder 104b comprises one intake valve 108b and one exhaust valve 110b. It is appreciated, however, that the engine may comprise any appropriate number of multi-valve cylinders 104a, each having at least two intake valves 108a and/or at least two exhaust valves 110a, and any appropriate number of further cylinders 104b, each having fewer intake valves 108b and/or exhaust valves 110b than each multi-valve cylinder 104a. For example, the engine may comprise one multi-valve cylinder 104a and one further cylinder 104b. The multi-valve cylinder 104a of the engine may comprise two intake valves 108a and a single exhaust valve 110a, and the further cylinder 104b may comprise one intake valve 108b and one exhaust valve 110b. In another example, the multi-valve cylinder 104a may comprise three intake valves 108a and two exhaust valves 110a, and the further cylinder 104b may comprise two intake valves 108b and two exhaust valves 110b. It is also appreciated that for those engines comprising more than one multi-valve cylinder 104a, each multi-valve cylinder 104a may comprise a different number of intake valves 108a and/or a different number of exhaust valves 110a. Similarly, for those engines comprising more than one further cylinder 104b, each further cylinder 104b may comprise a different number of intake valves 108a and/or a different number of exhaust valves 110a.

In one example of the engine 100, at least one of each further cylinder 104b may be configured such that the valve lift height of at least one intake valve 108b and/or at least one exhaust valve 110b is greater than that of the intake valves 108a and/or the exhaust valves 110a of the or each multi-valve cylinder 104a. For example, a cam that controls the valve lift height of the intake valve 108b or the exhaust valve 110b of the further cylinder 104b may have a different profile and/or different eccentricity to a cam that controls the valve lift height of the intake valve 108a or the exhaust valve 110a of the multi-valve-cylinder 104a. Additionally and/or alternatively, the or at least one of each further cylinder 104b may be configured such that at least one intake valve 108b and/or at least one exhaust valve 110b is larger, for example has a larger diameter or opening size, than that of the intake valves 108a and/or the exhaust valves 110b of each multi-valve cylinder 104a. In this manner, the mass flow rate of air (or air-fuel mixture) into and out of the further cylinder 104b may be comparable to the mass flow rate of air (or air-fuel mixture) into and out of the multi-valve cylinder 104a. Consequently, the performance and/or efficiency of the further cylinder 104b is not compromised at higher-engine loads, despite the further cylinder 104b having a lower number of intake and/or a lower number of exhaust valves 108b, 110b than the multi-valve-cylinder 104a.

A cylinder deactivation system 112 is configured to selectively deactivate at least one further cylinder 104b. The cylinder deactivation system 112 may comprise one or more switchable mechanisms configured to disengage the intake valves 108b and/or the exhaust valves 110b of at least one further cylinder 104b from a camshaft of the engine.

In one example, the cylinder deactivation system 112 may comprise one or more switchable roller finger followers configured to selectively actuate the intake valves 108b and/or exhaust valves 110b of at least one further cylinder 104b for the purpose of cylinder deactivation. Each switchable roller finger follower may comprise one or more hydraulic elements configured to adjust the operational configuration of the switchable roller finger follower, thereby enabling the selective actuation of the intake valves 108b and/or exhaust valves 110b of at least one further cylinder 104b.

Additionally and/or alternatively, the cylinder deactivation system 112 may comprise one or more collapsible lash adjusters, which may also be referred to as hydraulic valve lifters or hydraulic tappets, configured to selectively decouple the intake valves 108b and/or exhaust valves 110b of at least one further cylinder 104b from a rocker arm or a cam follower for the purpose of cylinder deactivation. Each collapsible lash adjuster may comprise one or more hydraulic elements configured to adjust the operational configuration of the collapsible lash adjuster thereby enabling the selective decoupling of the intake valves 108b and/or exhaust valves 110b of at least one further cylinder 104b, for example by preventing contact between the lash adjusters and a push rod, valve stem or rocker mechanism.

The cylinder deactivation system 112 may comprise a hydraulic system, for example a hydraulic circuit, configured to supply hydraulic fluid to the switchable finger followers and/or the collapsible lash adjusters.

The cylinder deactivation system 112 may be further configured to selectively deactivate at least one multi-valve cylinder 104a. In this manner, the cylinder deactivation system 112 may be configured to deactivate any number of multi-valve cylinders 104a and/or further cylinders 104b by virtue of changing the operational configuration of the switchable finger followers and/or the collapsible lash adjusters associated with the operation of one or of the multi-valve cylinders 104a and/or further cylinders 104b. It is appreciated, however, that the cylinder deactivation system 112 may comprise any appropriate mechanism configured to deactivate one or more multi-valve cylinders 104a and/or further cylinders 104b, for example the cylinder deactivation system 112 may comprise a mechanism configured to slide one or more cams of the camshaft along the length of the camshaft in order to disengage a valve actuation mechanism.

In the example of FIG. 1B, cylinder deactivation system 112 is configured to selectively deactivate the intake and the exhaust valve 108b, 110b of the further cylinder 104b. It is appreciated, therefore, that by providing fewer intake and/or exhaust valves 108b, 110b of the further cylinder 104b, the engine according to the present disclosure permits a reduction in the number of complex and expensive parts, for example the switchable roller finger followers and/or the collapsible lash adjusters, that are required to deactivate the cylinder.

As mentioned above, the cylinder deactivation system 112 may be further configured to selectively deactivate at least one of the multi-valve cylinders 104a shown in FIG. 1B. In one example, the cylinder deactivation system 112 may be configured to deactivate at least one intake valve 108a and/or at least one exhaust valve 110a of at least one multi-valve cylinder 104a. In this manner, the cylinder deactivation system 112 may be configured to selectively deactivate any combination of multi-valve cylinders 104a and/or further cylinders 104b dependent upon the operational requirements of the engine.

The engine 100 may comprise one or more control devices 114 configured to deactivate at least one further cylinder 104b. The control device 114 may be configured to adjust the valve lift height of at least one intake valve 108b and/or at least one exhaust valve 110b of at least one further cylinder 104b. In one example, the control device 114 may be configured to monitor the operational state of the engine and/or the motor vehicle and provide a signal to the cylinder deactivation system 112 for the purpose of deactivating at least one further cylinder 104b by way of preventing at least one intake valve 108b and/or at least one exhaust valve 110b from opening. The control device 114 may be configured to provide a signal to the cylinder deactivation system 112 to increase the valve lift height of at least one intake valve 108b and/or at least one exhaust valve 110b in order to increase the air mass flow rate into and out of at least one further cylinder 104b. The control device 114 may be one non-limiting example of controller 12 of FIG. 1A. In some examples, control device 114 may be separate from but communicatively coupled to controller 12.

In another example, the control device 114 may be configured to deactivate at least one multi-valve cylinder 104a and/or adjust the valve lift height of at least one intake valve 108a and/or at least one exhaust valve 110a of at least one multi-valve cylinder 104a.

In another example, the control device 114 may be configured to adjust the timing of one or more of the intake valves 108a, 108b and/or exhaust valves 110a, 110b of the or at least one of each multi-valve cylinder 104a and/or the or at least one of each further cylinder 104b respectively.

The present disclosure provides a method of controlling the engine, for example a method of controlling the power output from the engine and/or the level of emissions in the exhaust gases of the engine. The method comprises deactivating the or at least one of each further cylinder 104b of the engine by way of the cylinder deactivation system 112.

In one example, the method may comprise adjusting, for example increasing, the valve lift height of at least one intake valve 108b and/or at least one exhaust valve 110b of the or at least one of each further cylinder 104b. In a similar manner, the method may comprise deactivating the or at least one of each multi-valve cylinder 104a and/or adjusting the valve lift height of at least one intake valve 108a and/or at least one exhaust valve 110a of the or at least one of each multi-valve cylinder 104a.

In another example, the method may comprise adjusting the timing of one or more of the intake valves 108a, 108b and/or exhaust valves 110a, 110b of the or at least one of each multi-valve cylinder 104a and/or the or at least one of each further cylinder 104b respectively.

The method may comprise determining one or more operational requirements of the engine and/or the motor vehicle, and providing a signal to the cylinder deactivation system 112 for the purpose of controlling the power output from the engine and/or the level of emissions in the exhaust gases of the engine. In this manner, one or more of the further cylinders 104b and/or one or more of the multi-valve cylinders 104a may be deactivated in response to the operational requirements of the engine. Additionally and/or alternatively, the valve lift height and/or the timing of the intake valves 108a, 108b and/or the exhaust valves 110a, 110b of the or at least one of each multi-valve cylinder 104a and/or the or at least one of each further cylinder 104b respectively may be deactivated in response to the operational requirements of the engine.

Thus, as explained above and illustrated in FIG. 1B, an engine includes a plurality of cylinders. In one example, the plurality of cylinders includes a first cylinder having a first number of intake valves and a first number of exhaust valves and a second cylinder having a second number of intake valves and a second number of exhaust valves. The first number of intake valves may be greater than the second number of intake valves. In one example, the first number of intake valves may be two and the second number of intake valves may be one. Additionally or alternatively, the first number of exhaust valves may be larger than the second number of exhaust valves. For example, the first number of exhaust valves may be two and the second number of exhaust valves may be one. The engine may include multiple first cylinders and/or second cylinders. In the example illustrated in FIG. 1B, the engine includes three first cylinders and one second cylinder. However, other configurations are possible, such as a six-cylinder engine having four first cylinders and two second cylinders.

Each second cylinder of the engine may be operatively coupled to a cylinder deactivation system. As described above, the cylinder deactivation system is configured to selectively deactivate each second cylinder via switchable finger followers and/or collapsible lash adjusters, for example. The cylinder deactivation system may deactivate one or both of the intake valve(s) and exhaust valve(s) of each second cylinder. In some examples, the cylinder deactivation system may be configured to only deactivate the second cylinders. That is, the cylinder deactivation system may not be operatively coupled to the first cylinders, and hence the first cylinders may not be deactivatable. As such, the second cylinders may be referred to as deactivatable cylinders while the first cylinders may be referred to as non-deactivatable cylinders.

When the deactivatable cylinders are active (e.g., when the cylinder deactivation system in inactive and the intake and exhaust valve(s) of the deactivatable cylinders are operating and combustion is occurring the deactivatable cylinders), intake air flows into the deactivatable cylinders via fewer intake valves and/or exhaust gas flows out of the deactivatable cylinders via fewer exhaust valves than the non-deactivatable cylinders. Thus, air flow among all the cylinders of the engine may be imbalanced, leading to variable torque generation among the cylinders. To counteract this effect, the intake and/or exhaust ports and corresponding valves of the deactivatable cylinders may be larger (e.g., larger cross-sectional area) than respective intake and/or exhaust ports and corresponding valves of the non-deactivatable cylinders. Additionally or alternatively, the intake and/or exhaust valves of the deactivatable cylinders may actuated with a greater amount of lift than respective valve lift of the intake and/or exhaust valves of the non-deactivatable cylinders. In this way, the air flow through the deactivatable cylinders may be matched to the non-deactivatable cylinders.

Turning to FIG. 2, a method 200 for selectively deactivating cylinders in an engine is presented. Method 200 may be carried out according to non-transitory instructions stored in memory and executed by an electronic controller, such as controller 12 and/or control device 114 of FIGS. 1A-1B. Method 200 may be executed in combination with additional sensors and/or actuators, such as the cylinder deactivation system of FIG. 1 B, intake and exhaust valve actuation mechanisms, engine speed and/or load sensors, and fuel injectors, for example.

At 202, method 200 includes determining operating parameters. The determined operating parameters may include, but are not limited to, engine speed, engine load, engine temperature, mass air flow, boost pressure, etc. At 204, method 200 includes determining if cylinder deactivation is indicated. During cylinder deactivation, one or more cylinders of the engine are deactivated and air flow and fuel injection amounts to the remaining cylinders are increased to maintain requested torque. In doing so, active cylinders can be operated near their optimum efficiency, increasing the overall operating efficiency of the engine. Cylinder deactivation may be initiated in response to engine speed and/or load dropping below a threshold speed/load point in one example. In another example, cylinder deactivation may be initiated if a driver demanded torque is less than a threshold. Further, cylinder deactivation may be enabled only if engine coolant temperature is above a threshold to preempt cold cylinder conditions related issues (e.g., cylinder deactiavtion during cold engine temperatures may increase emissions).

If cylinder deactivation is not indicated, method 200 proceeds to 214 to operate with all cylinders active, which will be described in more detail below. If cylinder deactivation is indicated, method 200 proceeds to 206 to control the cylinder deactivation system to deactivate one or more selected cylinders. The cylinders selected for deactivation may be the deactivatable cylinders coupled to the cylinder deactivation system, e.g., the cylinder or cylinders that include fewer intake and/or exhaust valves than the remaining cylinders, also referred to as the further cylinders of FIG. 1B. In one example, only the deactivatable cylinders are selected to be disabled. Depending on requested torque, all of the deactivatable cylinders may be disabled, or a subset of the deactivatable cylinders may be disabled. As explained previously, the cylinder deactivation system may deactivate the intake and/or exhaust valves of the selected cylinders. In some examples, fuel injection to the selected cylinders may also be deactivated.

At 208, method 200 includes delivering fuel to and actuating the valves of the remaining cylinders to carry out combustion and deliver the requested torque. Thus, in response to a request to deactivate at least some cylinders, one or more deactivatable cylinders are disabled and the remaining cylinders receive intake air and fuel, and expel exhaust gas in order to deliver requested torque. The active cylinders may receive an increased amount of fuel and/or a throttle position of an intake throttle may be adjusted in response to deactivating the selected cylinders.

At 210, method 200 determines if cylinder reactivation is indicated. Cylinder reactivation may be indicated in response to driver requested torque increasing above a threshold and/or in response to engine speed and/or load increasing above a threshold. If cylinder reactivation is not indicated, method 200 continues back to 208 to carry out combustion in only the active cylinders and not in the selected, deactivated cylinders. If cylinder reactivation is indicated, method 200 proceeds to 212 to control the cylinder deactivation system to reactivate the one or more selected cylinders. At 214, fuel is delivered to each cylinder according to a specified cylinder firing order and the intake and exhaust valves are actuated for all cylinders, in order to carry out combustion in all cylinders of the engine. Further, as explained above, if cylinder deactivation is not indicated at 204, the method proceeds to 214 to operate the engine with all cylinders firing (e.g., no cylinders are deactivated). The deactivatable cylinders, which may have been previously disabled but are now active, may be operated with a greater amount of valve lift than the non-deactivatable cylinders, in some examples.

At 216, method 200 optionally includes adjusting the fueling of the deactivatable cylinders relative to the non-deactivatable cylinders based on engine speed and load. As explained previously, to counteract air flow differences between the deactivatable cylinders and the non-deactivatable cylinders due to the different number of intake and/or exhaust valves, the deactivatable cylinders may have larger intake and/or exhaust ports and/or may be operated with a greater amount of valve lift than the non-deactivatable cylinders. However, during some conditions air flow differences may still result, which may lead to air-fuel ratio imbalance in the deactivatable cylinders, for example. Thus, the deactivatable cylinders may receive more or less fuel than the non-deactivatable cylinders during some conditions. For example, at some engine speed and loads (e.g., high load), the deactivatable cylinders may receive a greater amount of air flow than the non-deactivatable cylinders, due to the smaller cross-sectional diameter of the two or more intake ports of the non-deactivatable cylinders. Thus, during high load conditions, to prevent cylinder air-fuel ratio imbalance, the deactivatable cylinders may receive a greater amount of fuel than the non-deactivatable cylinder, even though all cylinders are commanded to the same air-fuel ratio.

In some examples, the controller may learn the air-fuel ratio imbalance for each cylinder at each engine/speed load point and adjust fueling accordingly. To learn the respective imbalances of each cylinder, the controller may receive feedback from an imbalance sensor located in the exhaust system of the engine, for example. The imbalance sensor may be an oxygen sensor that is capable of discretely sampling each cylinder's exhaust at a timing that correlates with release of exhaust gas from that cylinder. In other examples, the controller may receive output from an exhaust oxygen sensor and determine based on other, corresponding parameters which cylinder's combustion products the exhaust is comprised of when the oxygen sensor signal is sampled in order to correlate exhaust oxygen concentration with each respective cylinder. Other mechanisms for determining cylinder air-fuel ratio imbalance are within the scope of this disclosure. Once the imbalance for each cylinder at a variety of engine speed and load points is measured, a look-up table may be populated and stored for future reference, and fueling may be adjusted based on the look-up table.

Thus, the systems and methods described above provide for a system including an engine having a first cylinder and a second cylinder, airflow through the first cylinder controlled by two intake valves and two exhaust valves, airflow through the second cylinder controlled by one intake valve and one exhaust valve; a cylinder deactivation system; and a controller storing instructions executable to deactivate the second cylinder by controlling the cylinder deactivation system to deactivate one or more of the one intake valve and one exhaust valve of the second cylinder.

In a first example of the system, the system may include wherein the first cylinder includes two intake ports each having a first diameter, wherein the second cylinder includes one intake port having a second diameter, and wherein the second diameter is larger than the first diameter. A second example of the system may optionally include the first example and may additionally include wherein the first cylinder includes two exhaust ports each having a first diameter, wherein the second cylinder includes one exhaust port having a second diameter, and wherein the second diameter is larger than the first diameter. A third example of the system may optionally include one or more of the first example and the second example and may further comprise a valve actuation system, wherein when the second cylinder is activated, the valve actuation system is configured to actuate the intake valve of the second cylinder with a greater amount of lift than an amount of lift used to actuate the two intake valves of the first cylinder. A fourth example of the system may optionally include one or more of the first, second, and third examples and further comprises a first fuel injector coupled to the first cylinder and a second fuel injector coupled to the second cylinder, and the controller may store further instructions executable to adjust an amount of fuel supplied by the second fuel injector relative to an amount fuel supplied by the first fuel injector based on engine speed and load.

The systems and methods described above also provide for a method, comprising during a first condition, flowing intake air for combustion into a first cylinder via a first intake valve and a second intake valve, and flowing intake air for combustion into a second cylinder via a third intake valve; and adjusting an amount of fuel supplied to the first cylinder relative to an amount fuel supplied to the second cylinder based on engine speed and load. The method further comprises, responsive to a second condition, deactivating the second cylinder. In a first example of the method, the first condition comprises engine load above a threshold and the second condition comprises engine load below the threshold. A second example of the method optionally includes the first example and further comprises, during the first condition, expelling exhaust gas from the first cylinder via a first exhaust valve and a second valve, and expelling exhaust gas from the second cylinder via a third exhaust valve. A third example of the method optionally includes one or more of the first and second examples, and further includes wherein deactivating the second cylinders comprises deactivating one or more of the third intake valve and third exhaust valve, and further comprises, during the second condition, flowing intake air for combustion into the first cylinder via the first intake valve and second intake valve and expelling exhaust gas from the first cylinder via the first exhaust valve and second exhaust valve.

The method may include during the first condition, flowing intake air for combustion into the first cylinder via the first intake valve and second valve and flowing intake air for combustion into the second cylinder only via the third intake valve. Adjusting the amount of fuel supplied to the first cylinder relative to the amount of fuel supplied to the second cylinder based on engine speed and load may include maintaining the first and second cylinders at substantially equal air-fuel ratios as air flow through the first cylinder changes relative to air flow through the second cylinder as speed and/or load change. In one example, the amount of fuel supplied to the first cylinder may be less than an amount of fuel supplied to the second cylinder at high engine load. In another example, the amount of fuel supplied to the first cylinder may be more than an amount of fuel supplied to the second cylinder at high engine load. Air flow through the first cylinder relative to air flow through the second cylinder at a given engine speed and/or load may be learned based on feedback from an exhaust oxygen sensor in one example.

It will be appreciated by those skilled in the art that although the invention has been described by way of example with reference to one or more examples, it is not limited to the disclosed examples and that alternative examples could be constructed without departing from the scope of the invention as defined by the appended claims.

1. An engine comprising:
one or more multi-valve cylinders each having a plurality of intake valves and/or a plurality of exhaust valves; and
one or more further cylinders each having fewer intake valves and/or fewer exhaust valves than each multi-valve cylinder, wherein a cylinder deactivation system of the engine is configured to selectively deactivate at least one of each further cylinder.

2. The engine according to claim 1, wherein a valve lift height of at least one intake valve and/or at least one exhaust valve of at least one of each further cylinder is greater than that of the plurality of intake valves and/or the plurality of exhaust valves of the one or more multi-valve cylinders.

3. The engine according to claim 1, wherein at least one intake valve and/or at least one exhaust valve of the or at least one of each further cylinder is larger than the plurality of intake valves and/or the plurality of exhaust valves of the one or more multi-valve cylinders.

4. The engine according to claim 1, wherein the cylinder deactivation system is configured to selectively deactivate at least one of the one or more multi-valve cylinders.

5. The engine according to claim 1, wherein the cylinder deactivation system comprises one or more switchable roller finger followers or one or more collapsible lash adjusters.

6. The engine according to claim 1, wherein each multi-valve cylinder comprises two intake valves.

7. The engine according to claim 1, wherein each multi-valve cylinder comprises two exhaust valves.

8. The engine according to claim 1, wherein each further cylinder comprises one intake valve.

9. The engine according to claim 1, wherein each further cylinder comprises one exhaust valve.

10. The engine according to claim 1, further comprising a control device configured to deactivate at least one of each further cylinder and/or adjust a valve lift height of at least one intake valve and/or at least one exhaust valve of at least one of each further cylinder.

11. The engine according to claim 10, wherein the control device is configured to deactivate at least one of each multi-valve cylinder and/or adjust a valve lift height of at least one intake valve and/or at least one exhaust valve of at least one of each multi-valve cylinder.

12. A system, comprising:
an engine having a first cylinder and a second cylinder, airflow through the first cylinder controlled by two intake valves and two exhaust valves, airflow through the second cylinder controlled by one intake valve and one exhaust valve;
a cylinder deactivation system; and
a controller storing instructions executable to deactivate the second cylinder by controlling the cylinder deactivation system to deactivate one or more of the one intake valve and one exhaust valve of the second cylinder.

13. The system of claim 12, wherein the first cylinder includes two intake ports each having a first diameter, wherein the second cylinder includes one intake port having a second diameter, and wherein the second diameter is larger than the first diameter.

14. The system of claim 12, wherein the first cylinder includes two exhaust ports each having a first diameter, wherein the second cylinder includes one exhaust port having a second diameter, and wherein the second diameter is larger than the first diameter.

15. The system of claim 12, further comprising a valve actuation system, wherein when the second cylinder is activated, the valve actuation system is configured to actuate the intake valve of the second cylinder with a greater amount of lift than an amount of lift used to actuate the two intake valves of the first cylinder.

16. The system of claim 12, further comprising a first fuel injector coupled to the first cylinder and a second fuel injector coupled to the second cylinder, and wherein the controller stores further instructions executable to adjust an amount of fuel supplied by the second fuel injector relative to an amount fuel supplied by the first fuel injector based on engine speed and load.

17. A method, comprising:
during a first condition,
flowing intake air for combustion into a first cylinder via a first intake valve and a second intake valve, and flowing intake air for combustion into a second cylinder via a third intake valve; and
adjusting an amount of fuel supplied to the first cylinder relative to an amount fuel supplied to the second cylinder based on engine speed and load; and
responsive to a second condition, deactivating the second cylinder.

18. The method of claim 17, wherein the first condition comprises engine load above a threshold and the second condition comprises engine load below the threshold.

19. The method of claim 17, further comprising, during the first condition, expelling exhaust gas from the first cylinder via a first exhaust valve and a second valve, and expelling exhaust gas from the second cylinder via a third exhaust valve.

20. The method of claim 17, wherein deactivating the second cylinders comprises deactivating one or more of the third intake valve and third exhaust valve, and further comprising, during the second condition, flowing intake air for combustion into the first cylinder via the first intake valve and second intake valve and expelling exhaust gas from the first cylinder via the first exhaust valve and second exhaust valve.
